(19) United States
(12) Patent Application Publication
(10) Pub. No.: US 2013/0257249 A1
(43) Pub. Date: Oct. 3, 2013

(54) CHEST OF DRAWERS WITH DRAWER LOCKS

(71) Applicant: Meir Avganim, Gealya, IL (US)

(72) Inventor: Meir Avganim, Gealya, IL (US)

(21) Appl. No.: 13/882,559

(22) PCT Filed: Nov. 2, 2011
(86) PCT No.: PCT/US11/58932

§ 371 Date: Jun. 17, 2013

Related U.S. Application Data
(60) Provisional application No. 61/409,549, filed on Nov. 3, 2010.

(51) Int. Cl. E05B 65/46; E05B 67/00

(52) U.S. Cl. CPC E05B 65/46; E05B 67/00
USPC 312/333; 70/78

(57) ABSTRACT

A locking arrangement for a drawer of a chest wherein the chest has a front wall into which the drawer is received and a back wall, the arrangement comprising a member extending from a back wall of the drawer, an opening for the member provided in the back wall of the chest, the member extending through the opening in the back wall of the chest when the drawer is fully inserted into the chest and wherein the member is adapted to receive a locking device for attachment to the member extending through the opening to prevent the drawer from being removed.

### FIELD OF THE INVENTION

The present invention generally relates to locking arrangements, and more specifically to locking of sliding drawers, e.g. in a chest of drawers.

### BACKGROUND OF THE INVENTION

Conventionally, lockable drawers are provided with a more or less sophisticated locking devices installed at the upper rim thereof with a throwable tongue, operated by a key. The tongue, in its projected operating position, is adapted to become inserted into a slot or cavity formed in the lower portion of the respective drawer frame.

This method of drawing locking has not been changed for centuries inspite of its obvious disadvantages: The need to prepare a cavity for fitting the locking device at the inner side of front drawer wall; and preparing the tongue-receiving slot.

The present invention aims to overcome these and other disadvantages, including substantially lowering the costs of such locking arrangements.

### DETAILED DESCRIPTION OF THE PREFERRED EMBODIMENT

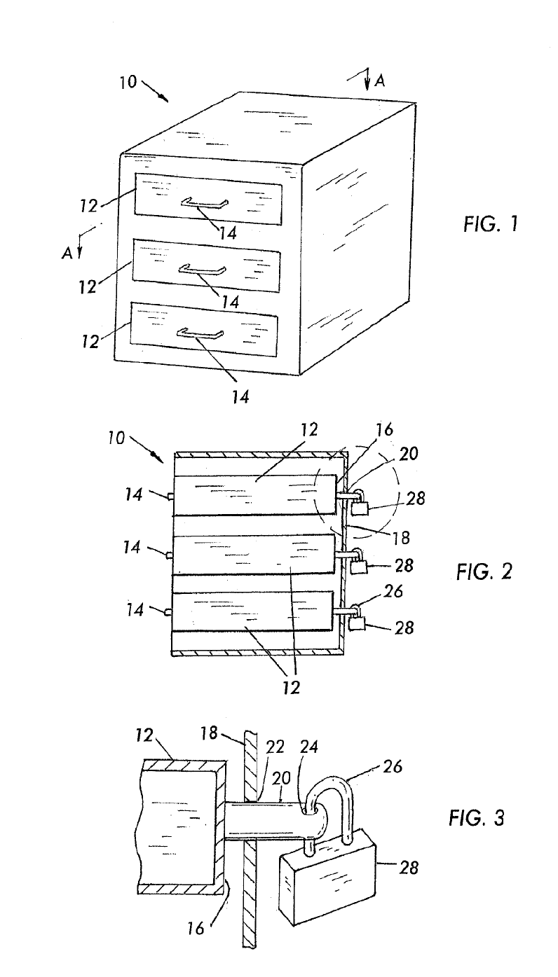

FIG. 1 is a front, three dimensional, schematic, front view of a chest-of-drawers suitable for implementation of the present invention;

FIG. 2 is a schematic cross-sectional view taken along line A-A of FIG. 1;

FIG. 3 is an enlarged detail of FIG. 2.

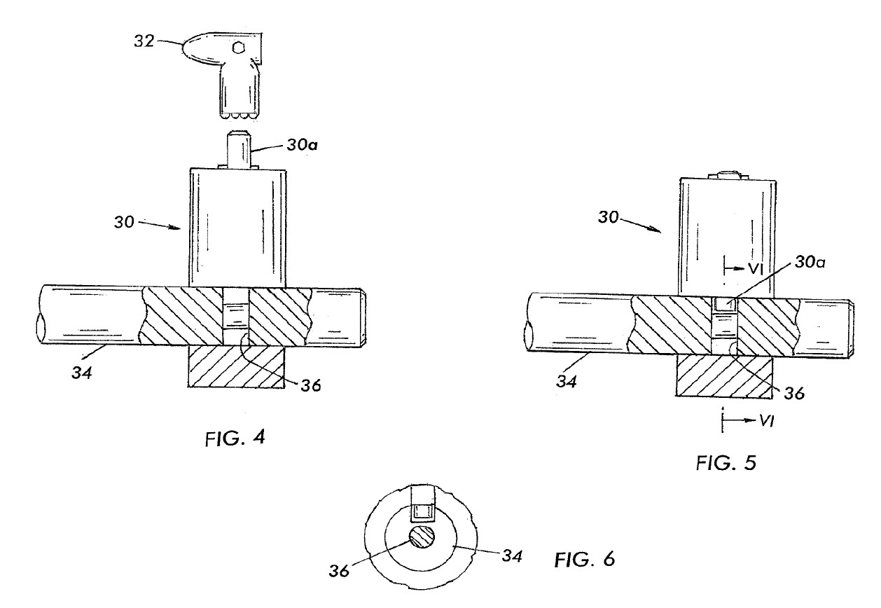

FIG. 4 is a cross-sectional view of a second embodiment of the present invention in the unlocked position;

FIG. 5 is similar to FIG. 4 but in the locked position; and

FIG. 6 is a section taken along line VI-VI of FIG. 5.

In FIG. 1, 10 generally denotes a typical chest-of-drawers, being a four-sided box made of wood or sheet-metal, with extractable drawers 12 having handles 14. The drawers 12 are slidable on guide-rails (not shown).

As seen in FIG. 2, and more clearly in FIG. 3, each drawer 12 has a back wall 16 which, in the fully inserted position of the drawer, reaches close to back wall 18 of the box 10.

A lock pin 20 is attached to the drawer wall 16, being of a length sufficient to pass through an opening 22 made for that purpose in the wall 18. A bore 24 is formed close to the free end of the pin 20 for passing therethrough yoke 26 of padlock 28 or any equivalent thereof.

Hence, locking and unlocking of drawer 12 is easily completed, provided, however, that the back side of the chest of drawers is normally exposed or readily accessible.

In the embodiment of FIGS. 4-6, the padlock of the previous embodiment is replaced by a push-button type lock 30 operable by key 32.

The lock 30 is associated with an eyelet freely fitting around locking pin 34 (which is equivalent to the pin 20 of the former embodiment).

Rather than a throughgoing opening 22, a circular slot 36 is formed, allowing the insertion of lock pin of the push-button 30a thereinto in the locking position as shown in FIGS. 5 and 6.

What is claimed is:

1. A locking arrangement for a drawer of a chest wherein the chest has a front wall into which the drawer is received and a back wall, the arrangement comprising:
a member extending from a back wall of the drawer;
an opening for the member provided in the back wall of the chest,
the member extending through the opening in the back wall of the chest when the drawer is fully inserted into the chest; and
wherein the member is adapted to receive a locking device for attachment to the member extending through the opening to prevent the drawer from being removed.

2. The locking arrangement of claim 1, wherein the member comprises a pin.

3. The locking arrangement of claim 1, wherein the pin has an opening therein for receiving a portion of the locking device.

4. The locking arrangement of claim 3, wherein the locking device comprises a padlock having a yoke receivable in the opening of the pin.

5. The locking arrangement of claim 3, wherein the locking device comprises a push-button lock with a locking part that is received in the opening in the pin.

6. The locking arrangement of claim 5, wherein the opening in the pin comprises a circular slot extending around the pin for receiving the locking part.

7. The locking arrangement of claim 5, wherein the locking device employs a key to unlock it.
